(19) United States
(12) Patent Application Publication
(10) Pub. No.: US 2004/0213182 A1
(43) Pub. Date: Oct. 28, 2004

(54) Apparatus and method for controlling a reverse rate in a mobile communication system supporting packet data service

(76) Inventors: Hoon Huh, Seongnam-si (KR); Soon-Young Yoon, Seongnam-si (KR); Seok-Wan Rhu, Seoul (KR)

Correspondence Address: Peter L. Kendall, Roylance, Abrams, Berdo & Goodman, L.L.P., Suite 600, 1300 19th Street, N.W., Washington, DC, 20036, US

(21) Appl. No.: 10/754,602

(22) Filed: Jan. 12, 2004

(30) Foreign Application Priority Data
Jan. 10, 2003 (KR) 2003-1727
Jan. 10, 2003 (KR) 2003-1697

(51) Int. Cl. H04Q 7/00

(52) U.S. Cl. 370/332; 370/252

(57) ABSTRACT

A method and apparatus for controlling by a mobile terminal a rate of packet data transmitted in a reverse direction from the mobile terminal to base station in a mobile communication system. The method and apparatus comprise determining a transmission signal-to-noise ratio of a signal on a forward channel transmitted from the base station, and selecting one transition probability set from predetermined transition probability sets according to a value of the signal-to-noise ratio; selecting one transition probability from the selected transition probability set according to reverse rate control information received from the base station, and changing the transmission rate according to the selected transition probability.

### PRIORITY

This application claims priority under 35 U.S.C. § 119 to an application entitled “Apparatus and Method for Controlling Reverse Rate in a Mobile Communication System Supporting Packet Data Service” filed in the Korean Intellectual Property Office on Jan. 10, 2003 and assigned Serial No. 2003-1697, and an application entitled “Apparatus and Method for Controlling Reverse Rate in a Mobile Communication System Supporting Packet Data Service” filed in the Korean Intellectual Property Office on Jan. 10, 2003 and assigned Serial No. 2003-1727, the contents of both of which are incorporated herein by reference.

### BACKGROUND OF THE INVENTION

1. Field of the Invention

The present invention relates generally to a mobile communication system, and in particular, to an apparatus and method for controlling a reverse rate so as to efficiently utilize a load of a reverse link during a packet data service.

2. Description of the Related Art

Due to new communication technologies, there are increasing numbers of users who desire to use a packet data service, such as web, File Transfer Protocol (FTP) and moving image services, in a wireless environment. Traffic of such a packet data service has a very asymmetric characteristic. That is, traffic transferred from a server providing the service to a user is larger than the traffic transferred from the user to the server. When a data service based on mobile communication is taken into consideration, since a server is connected to a mobile terminal (MT) of a user via a base station for mobile communication, the amount of traffic on a forward link transmitted from a base station to a mobile terminal is larger than the amount of traffic on a reverse link transmitted from the mobile terminal to the base station.

CDMA2000 Evolution-Data Only (1× EV-DO), High Rate Packet Data Air interface (HRPDA) and Evolution-Data and Voice (1× EV-DV) proposed by the 3^{rd} Generation Partnership Project 2 (3GPP2), a mobile communication standard organization, and High Speed Downlink Packet Access (HSDPA) proposed by the 3^{rd} Generation Partnership Project (3GPP), another mobile communication standard organization, have been designed in consideration of such an asymmetric characteristic.

In particular, CDMA2000 1× EV-DO, in a forward link, uses a high-order modulation scheme such as 16-ary Quadrature Amplitude Modulation (16QAM) and 8-ary Phase Shift Keying (8PSK), and a coding rate, and is designed to achieve high throughput by using multi-user diversity technology based on Adaptive Modulation and Coding Scheme (AMCS), Hybrid Automatic Repeat Request (H-ARQ), and fat-pipe scheduling. In addition, in a reverse link, CDMA2000 1× EV-DO employs a scheme of controlling scheduling and load in consideration of a burst characteristic of packet data.

FIG. 1 is a block diagram illustrating a structure of a reverse traffic channel used in a common CDMA2000 1× EV-DO system. Referring to FIG. 1, a reverse traffic channel 100 comprises a pilot channel 110, a Medium Access Control (MAC) channel 120, an Acknowledgement (ACK) channel 130, and a data channel 140. The MAC channel 120 is subdivided into an Reverse Rate Indicator (RRI) channel 122 and a Data Rate Control (DRC) channel 124.

The pilot channel 110 is continuously transmitted for synchronization and channel estimation on a traffic channel at a base station. The RRI channel 122 transmits an indicator indicating a rate of a traffic channel, and the DRC channel 124 feeds back channel condition information of a forward link for an adaptive modulation and coding scheme (AMCS) in a forward link. The ACK channel 130 transmits ACK/NACK indicating whether packet data received over a forward link is defective or not, in order to support H-ARQ. The data channel 140 transmits a data packet of a user.

The reverse traffic channel 100 is designed to support 5 possible rates of 9.6 Kbps, 19.2 Kbps, 38.4 Kbps, 76.8 Kbps, and 153.6 Kbps. In order to determine a rate of traffic channels for mobile terminals and to control a load of the traffic channels, scheduling is needed. A pre-CDMA2000 1× EV-DO mobile communication system adopts a scheme in which a base station determines a rate of mobile terminals by performing scheduling depending on feedback information received from the mobile terminals, and informs the mobile terminals of the determined rate.

However, such a scheme increases time delay. Therefore, when the burst characteristic of packet data is taken into consideration, this scheme is difficult to utilize traffic and channel information at an appropriate time. In this scheme, reverse scheduling information (i.e., a rate) is delivered over a forward link, causing an increase in a load of the forward link undesirably. Therefore, the CDMA2000 1× EV-DO mobile communication system adopts a scheme in which if a base station measures a reverse load by the frame and indicates whether a rate should be increased or decreased, then a mobile terminal increases or decreases its rate based on probability. For this purpose, Reverse Activity Bit (RAB), transition probability, and rate limit parameters are used.

RAB is 1-bit information included in each forward frame, and is information for directing a mobile terminal to increase or decrease its rate. A base station controls a reverse load by monitoring a load of a reverse link and properly setting RAB. For example, if a load of a reverse link is lower than a predetermined threshold, the base station sets RAB to ‘0’ to direct the mobile terminal to increase its rate, whereas if the load of the reverse link is higher than the predetermined threshold, the base station sets RAB to ‘1’ to direct the mobile terminal to decrease its rate.

Transition probability is classified into transition probability to a high rate and transition probability to a low rate, for each rate. A mobile terminal generates a random number between 0 and 1, when determining a rate of a reverse traffic channel using the transition probability. That is, the mobile terminal compares the generated random number with the transition probability to a high rate (hereinafter referred to as “transition-to-high-rate probability”) or the transition probability to a low rate (hereinafter referred to as “transition-to-low-rate probability”) according to RAB, and changes or maintains a current rate according to whether the random number falls within the transition probability.

As an example, the transition-to-high-rate probability is expressed as Transition009k6_{—}019k2, Transition019k2_{—}038k4, Transition038k4_{—}076k8 and Transition076k8_{—}153k6 according to a current rate. Typically, Transition019k2_{—}038k4 refers to transition probability that a current rate 19.2 Kbps can be increased to 38.4 Kbps. If RAB received from a base station is ‘0’, i.e., if a control signal indicating a rate-up instruction is received, a mobile terminal compares the generated random number with transition-to-high-rate probability corresponding to a current rate. As a result of the comparison, if the random number is smaller than the transition-to-high-rate probability, i.e., if the random number falls within the transition-to-high-rate probability, the mobile terminal transitions to a next high rate. However, if the random number is larger than the transition-to-high-rate probability, i.e., if the random number does not fall within the transition-to-high-rate probability, the mobile terminal maintains the current rate.

As another example, the transition-to-low-rate probability is expressed as Transition019k2_{—}009k6, Transition038k4_{—}019k2, Transition076k8_{—}038k4 and Transition153k6_{—}076k8 according to a current rate. If RAB received from a base station is ‘1’, i.e., if a control signal indicating a rate-down instruction is received, a mobile terminal compares the generated random number with transition-to-low-rate probability corresponding to a current rate. As a result of the comparison, if the random number is smaller than the transition-to-low-rate probability, i.e., if the random number falls within the transition-to-low-rate probability, the mobile terminal transitions to a next low rate. However, if the random number is larger than the transition-to-low-rate probability, i.e., if the random number does not fall within the transition-to-low-rate probability, the mobile terminal maintains the current rate.

The rate limit parameter represents a maximum rate at which a mobile terminal can transmit data over a reverse link. The rate limit is determined by a base station, and applies to all mobile terminals providing data service over a synchronous control channel by periods (e.g., every 768 slots), or transmitted to a particular mobile terminal using a separate designated signal.

A scheduling procedure for controlling a reverse rate using the above parameters by a mobile terminal will now be described in detail with reference to FIG. 2. FIG. 2 illustrates a condition table used by a mobile terminal in determining a reverse rate. CurrentRate shown in FIG. 2 represents rates of a frame before scheduling, and at initial transmission, a current rate is 0 as illustrated in FIG. 2. In addition, MaxRate represents a maximum rate assignable after scheduling, and NewRate, which is discussed below, represents a rate assigned by scheduling.

A mobile terminal performs the following operations using the table in FIG. 2:

1. A mobile terminal generates a combined busy bit (CombinedBusyBit; CBB) by performing a logical OR operation on RABs received from all base stations in communication due to its soft handoff.

2. The mobile terminal generates a random number X having uniform distribution between 0 and 1. If a condition given based on a current rate and a combined busy bit for the generated random number is ‘True’ in the condition table illustrated in FIG. 2, the mobile terminal determines a rate in MaxRateTrue as a maximum rate, whereas if the condition is ‘False’, the mobile terminal determines a rate in MaxRateFalse as a maximum rate.

3. A new rate is determined as a smaller value from the determined maximum rate and a predetermined limit rate.

4. The mobile terminal determines whether data transmission at the new rate determined based on an available transmission output is possible, and if the data transmission is impossible, the mobile terminal decreases the new rate to an available maximum rate.

5. In addition, the mobile terminal determines whether an amount of transmission user data is smaller than an amount of data transmittable at the determined new rate, and if the amount of transmission user data is smaller than the amount of data transmittable at the determined new data, the mobile terminal decreases the new rate to a minimum rate at which the transmission user data can be transmitted all.

6. The mobile terminal transmits data at a new rate optimized through the processes of steps 4 and 5.

For example, if a current rate is 19.2 Kbps, RABs received from all base stations in soft handoff are ‘0’, a Transition019k2_{—}038k4 value is 0.3, and a limit rate is 153.6kbps, then a combined busy bit CBB is ‘0’, so this corresponds to the 4^{th} line of the table in FIG. 2. If a generated random number X is 0.2, the condition becomes ‘True’, so that a maximum rate becomes 38.4 Kbps. If the above-stated transmission output and packet data amount conditions are both satisfied, a new rate of the next frame is determined as 38.4 Kbps.

Meanwhile, a base station determines RAB by measuring a reverse load or Rise Over Thermal (ROT). First, an ROT-based scheme will be described. ROT represents a ratio of thermal noise power to total reception power, and when the base station uses a plurality of reception antennas, ROT Zⱼ for a j^{th} antenna is calculated by

Zⱼ=I_{O}/N_{O}=(I_{SC}+I_{OC}+N_{O})/N_{O} (1)

In Equation (1), I_{O} is total reception power spectral density, and represents the sum of reception power I_{SC} from mobile terminals belonging to a corresponding cell, reception power I_{OC} from mobile terminals belonging to other adjacent cells, and thermal noise power N_{O}. After calculating ROTs Zⱼ for j^{th} antennas in accordance with Equation (1), if a maximum value among ROTs calculated for the antennas is larger than a predetermined threshold Z_{T}, the base station sets RAB to ‘1’, and otherwise, the base station sets RAB to ‘0’.

The above-stated method for controlling a rate of a reverse link does not utilize channel information between a base station and a mobile terminal, unlike a method for controlling a rate of a forward link. In a forward link, a base station analyzes a channel condition depending on condition information, i.e., signal-to-noise ratios (SNR), of forward channels, fed back by mobile terminals, and assigns a higher rate to a mobile terminal having a better channel condition. In contrast, in a reverse link where a rate is controlled as described above, the same transition probability, RAB and rate limit are applied to all mobile terminals regardless of their channel conditions, and all the mobile terminals determine their rates with the same probability.

A mobile terminal having a poor reverse link's channel condition uses lower transmission power for the same rate, compared with a mobile terminal not having a poor reverse link's channel condition. In addition, a mobile terminal having a good channel condition for a particular base station has a relatively poor channel condition for other base stations; therefore it generates relatively low interference to the other base stations. When a high rate is assigned to a mobile terminal near to a base station (i.e., a mobile terminal having a good channel condition), inter-cell interference can be remarkably reduced as compared with when a high rate is assigned to a mobile terminal located in the vicinity of the cell boundary. Nevertheless, the existing scheme does not utilize channel information of a reverse link, thus causing an increase in inter-cell interference and a reduction in throughput.

In addition, the existing reverse link rate control method is not associated with a rate of a forward link, thus reducing reverse throughput. Therefore, non-smooth protocol communication between upper application layers may limit forward throughput undesirably. That is, even though an upper application layer requires fast acknowledgement over a reverse link, if processing is delayed due to low reverse throughput, forward throughput will also be limited. Such reverse link's throughput is required to be associated with forward link's throughput according to provided service and upper application layer's protocol. However, the existing scheme does not consider forward throughput, thus limiting the forward throughput undesirably.

Next, a scheme for determining RAB based on a reverse load by a base station will be described. When a base station uses a plurality of reception antennas, a reverse load Yⱼ for a j^{th} antenna is calculated by

$${Y}_{j} = {𝒬}_{k}^{users} \frac{{E}_{cp}}{{I}_{o}} ( 1 + \frac{{E}_{C , DRC}}{{E}_{C , PILOT}} + \frac{{E}_{C , DATA} ( {R}_{k} )}{{E}_{C , PILOT}} ) \qquad ( 2 )$$

In Equation (2), E_{c,p} denotes reception energy of a pilot channel, I_{O} denotes total reception power spectral density, E_{C,DRC}/E_{C,PILOT} denotes a power ratio of a DRC channel to a pilot channel, and E_{C,DATA}(Rₖ)/E_{C,PILOT} denotes a power ratio of a data channel to a pilot channel where Rₖ represents a rate of a k^{th} user. After calculating loads Yⱼ for j^{th} antennas in accordance with Equation (2), if a maximum value among the loads Yⱼ calculated for the antennas is larger than a predetermined threshold Y_{T}, the base station sets RAB to ‘1’, and otherwise, the base station sets RAB to ‘0’.

Table 1 below shows throughput simulation results of a reverse link based on Equation (2). Scheduling parameters used here, i.e., such parameters as rate limit, transition probability and transmission power including E_{C,DRC}/E_{C,PILOT} and E_{C,DATA}(Rₖ)/E_{C,PILOT}, are illustrated in FIG. 3. An ACK channel is disregarded in the simulation, since its relative importance in the reverse load is very low.

TABLE 1

| Number of terminals | Throughput (Kbps) | Load |
|---|---|---|
| 4 | 248.02 | 0.48 |
| 8 | 267.73 | 0.61 |
| 12 | 250.06 | 0.63 |
| 16 | 217.82 | 0.88 |

As illustrated in FIG. 3, in a reverse link of the CDMA2000 1× EV-DO mobile communication system, as its rate is increased higher, a power ratio of overhead channels such as pilot channel and DRC channel to a data channel is reduced and a gain of a turbo code is increased. Therefore, for a constant load, transmitting data at a high rate by a small number of mobile terminals is superior to transmitting data at a low rate by a large number of mobile terminals in terms of throughput. That is, a decrease in number of mobile terminals leads to an increase in throughput.

However, in the simulation results illustrated in Table 1, throughput when the number of mobile terminals is 4 is lower than throughput when the number of mobile terminals is 8. In contrast, a reverse load for the case when the number of mobile terminals is 4 is much lower than a load threshold Y_{T} (=0.65625), and the reason is as follows. Since a transition probability is fixed, even though there is a margin in a reverse load, a reverse rate cannot be increased, and when a reverse link's condition becomes better, a rate of a mobile terminal cannot rapidly respond thereto.

Commonly, since transition-to-high-rate probability is set low and transition-to-low-rate probability is set high, it is difficult to increase a rate whereas it is easy to decrease a rate. The transition probability is fixed to a very conservative value in consideration of the worst case in which the number of mobile terminals is very large, and the transition probability, once it is initialized during call setup, cannot be changed. That is, since the existing system cannot change the transition probability, even though the number of mobile terminals is small and a reverse load has a margin, appropriate throughput cannot be achieved.

### SUMMARY OF THE INVENTION

It is, therefore, an object of the present invention to provide an apparatus and method for controlling a reverse rate in a mobile communication system.

It is another object of the present invention to provide an apparatus and method for controlling a reverse rate depending on transition probability in a mobile communication system.

It is further another object of the present invention to provide an apparatus and method for controlling a reverse rate by changing transition probability according to a channel condition in order to increase reverse throughput in a mobile communication system.

According to a first aspect of the present invention, a method provides for controlling by a mobile terminal a rate of packet data transmitted in a reverse direction from the mobile terminal to base station in a mobile communication system providing a packet data service. The method comprises the steps of: determining a signal-to-noise ratio of a signal on a forward channel transmitted from the base station, and selecting one of two or more predetermined transition probability sets according to a value of the signal-to-noise ratio; and selecting one transition probability corresponding to a current rate from the selected transition probability set according to reverse rate control information received from the base station, and changing the current rate according to the selected transition probability.

According to a second aspect of the present invention, a mobile terminal apparatus provides for controlling a rate of packet data transmitted in a reverse direction from a mobile terminal in a mobile communication system providing a packet data service. The apparatus comprises a measurer for measuring throughput of a forward channel from a base station; a selector for selecting one of two or more predetermined transition probability sets according to a value of the throughput of a forward channel; and a reverse rate controller for selecting one transition probability corresponding to a current rate from the selected transition probability set according to reverse rate control information received from the base station, and changing the current rate according to the selected transition probability.

According to a third aspect of the present invention, a method provides for controlling by a mobile terminal a rate of packet data transmitted in a reverse direction from the mobile terminal in a mobile communication system providing a packet data service. The method comprises the steps of determining throughput of forward data transmitted from a base station, and selecting one of two or more predetermined transition probability sets according to a value of the forward data throughput; and selecting one transition probability corresponding to a current rate from the selected transition probability set according to reverse rate control information received from the base station, and changing the current rate according to the selected transition probability.

According to a fourth aspect of the present invention, a mobile terminal apparatus provides for controlling a rate of packet data transmitted in a reverse direction from a mobile terminal in a mobile communication system providing a packet data service. The apparatus comprises a measurer for measuring throughput of a forward channel from a base station; a selector for selecting one of two or more predetermined transition probability sets according to a value of the throughput of a forward channel; and a reverse rate controller for selecting one transition probability corresponding to a current rate from the selected transition probability set according to reverse rate control information received from the base station, and changing the current rate according to the selected transition probability.

According to a fifth aspect of the present invention, a method provides for controlling by a base station a rate of packet data transmitted in a reverse direction from a mobile terminal in a mobile communication terminal providing a packet data service. The method comprises the steps of determining a reverse load in a base station area, and selecting one of two or more predetermined transition probability sets according to a value of the reverse load; and transmitting indication information for the selected transition probability set to mobile terminals in the base station area, generating reverse rate control information for controlling a reverse rate based on the transition probability set information, and transmitting the generated reverse rate control information.

According to a sixth aspect of the present invention, a method provides for controlling by a mobile terminal a rate of packet data transmitted in a reverse direction in a mobile communication system providing a packet data service. The method comprises the steps of receiving indication information for a transition probability set from a base station; selecting one transition probability set corresponding to the received indication information among two or more transition probability sets; and selecting one transition probability corresponding to a current rate from the selected transition probability set according to reverse rate control information received from the base station.

According to a seventh aspect of the present invention, a base station apparatus provides for controlling a rate of packet data transmitted in a reverse direction from a mobile terminal in a mobile communication system providing a packet data service. The apparatus comprises a measurer for measuring a reverse load in a base station area; a selector for selecting one of two or more predetermined transition probability sets according to a value of the reverse load; and a transmitter for transmitting indication information for the selected transition probability set to a mobile terminal in the base station area.

According to an eighth aspect of the present invention, a mobile terminal apparatus provides for controlling a rate of packet data transmitted in a reverse direction in a mobile communication system providing a packet data service. The apparatus comprises a receiver for receiving indication information for a transition probability set from a base station; a selector for selecting one transition probability set corresponding to the received indication information among two or more transition probability sets; and a reverse rate controller for selecting one transition probability corresponding to a current rate from the selected transition probability set according to reverse rate control information received from the base station, and changing the current rate according to the selected transition probability.

According to a ninth aspect of the present invention, a method provides for controlling by a base station a rate of packet data transmitted in a reverse direction from a mobile terminal in a mobile communication system providing a packet data service. The method comprises the steps of determining a reverse load in a base station area, and selecting one of transition probability offsets for a reference transition probability set previously determined according to a value of the reverse load; and transmitting the selected offset to mobile terminals in the base station area, generating reverse rate control information for controlling a reverse rate based on the offset, and transmitting the generated revere rate control information.

According to a tenth aspect of the present invention, a method provides for controlling by a mobile terminal a rate of packet data transmitted in a reverse direction from the mobile terminal in a mobile communication system providing a packet data service. The method comprises the steps of receiving from a base station a transition probability offset for a reference transition probability set previously determined according to a value of a reverse load; updating the reference transition probability set based on the received transition probability offset; and selecting one transition probability corresponding to a current rate from the updated transition probability set according to reverse rate control information received from the base station, and changing the current rate according to the selected transition probability.

According to an eleventh aspect of the present invention, a mobile terminal apparatus provides for controlling a rate of packet data transmitted in a reverse direction from a mobile terminal in a mobile communication system providing a packet data service. The apparatus comprises a receiver for receiving from a base station a transition probability offset for a transition probability set capable of achieving maximum throughput while maintaining a reverse load below a threshold; a calculator for updating a reference transition probability set previously determined using the received transition probability offset; and a reverse rate controller for selecting one transition probability corresponding to a current rate from the updated transition probability set according to reverse rate control information received from the base station, and changing the current rate according to the selected transition probability.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram illustrating a structure of a reverse traffic channel used in a common CDMA2000 Evolution Data Only (1× EV-DO) system;

FIG. 2 is a diagram illustrating a condition table used by a mobile terminal in determining a reverse rate;

FIG. 3 is a diagram illustrating tables for scheduling and transmission power parameters for throughput simulation of a reverse link;

FIG. 4 is a flowchart illustrating an operation of controlling a reverse rate using a reception signal-to-noise ratio of a forward pilot channel in a mobile terminal according to a first embodiment of the present invention;

FIG. 5 is a diagram illustrating an example of a table of transition probability sets;

FIG. 6 is a block diagram illustrating a mobile terminal apparatus for controlling a reverse rate using a reception signal-to-noise ratio of a forward pilot channel according to the first embodiment of the present invention;

FIG. 7 is a flowchart illustrating an operation of controlling a reverse rate using throughput of a forward data channel in a mobile terminal according to a second embodiment of the present invention;

FIG. 8 is a block diagram illustrating a mobile terminal apparatus for controlling a reverse rate using throughput of a forward data channel according to the second embodiment of the present invention;

FIG. 9 is a flowchart illustrating an operation of controlling a reverse rate in a base station using a plurality of transition probability sets according to a third embodiment of the present invention;

FIG. 10 is a flowchart illustrating an operation of controlling a reverse rate in a mobile terminal using a plurality of transition probability sets according to the third embodiment of the present invention;

FIG. 11 is a diagram illustrating an example of a table of transition probability sets;

FIG. 12 is a block diagram illustrating a base station apparatus for controlling a reverse rate using a plurality of transition probability sets according to the third embodiment of the present invention;

FIG. 13 is a block diagram illustrating a mobile terminal apparatus for controlling a reverse rate using a plurality of transition probability sets according to the third embodiment of the present invention;

FIG. 14 is a flowchart illustrating an operation of controlling a reverse rate in a base station using one transition probability set and a transition probability offset according to a fourth embodiment of the present invention;

FIG. 15 is a flowchart illustrating an operation of controlling a reverse rate in a mobile terminal using one transition probability set and a transition probability offset according to the fourth embodiment of the present invention;

FIG. 16 is a diagram illustrating an example of a table of reference transition probability sets and transition probability offsets;

FIG. 17 is a block diagram illustrating a base station apparatus for controlling a reverse rate using one transition probability set and transition probability offsets according to the fourth embodiment of the present invention; and

FIG. 18 is a block diagram illustrating a mobile terminal apparatus for controlling a reverse rate using one transition probability set and transition probability offsets according to the fourth embodiment of the present invention.

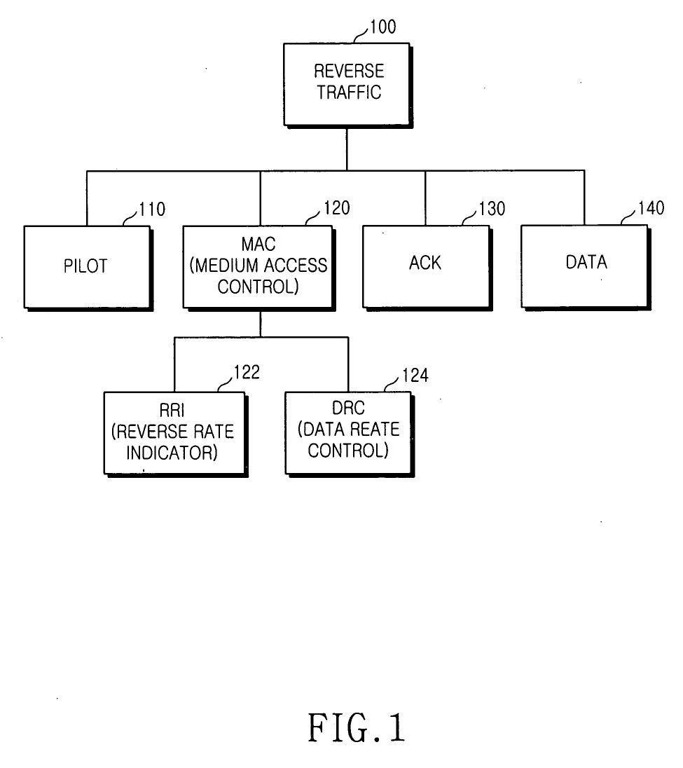

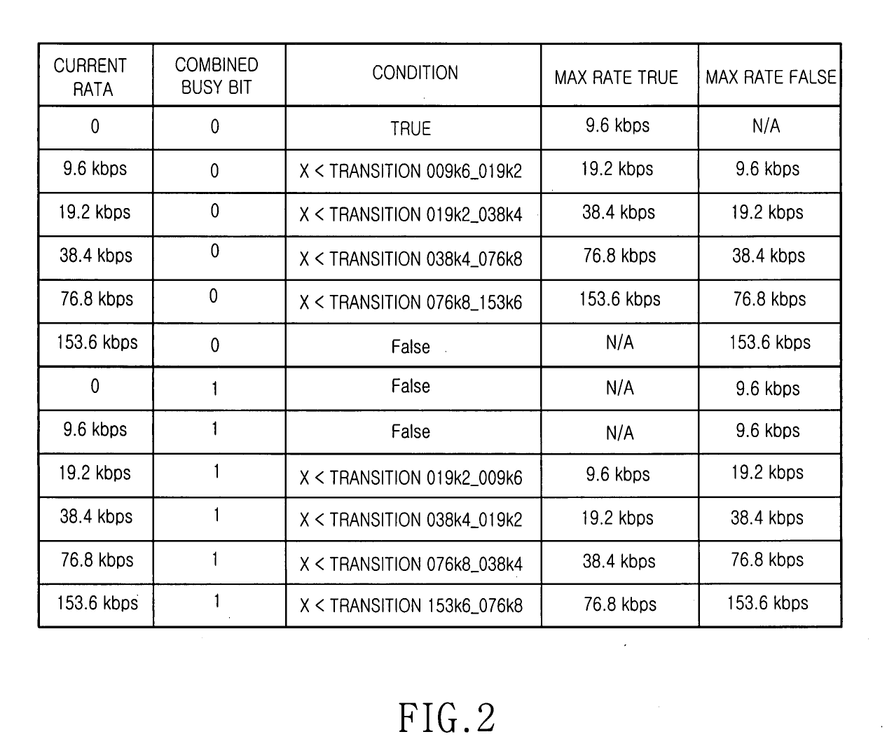

### DETAILED DESCRIPTION OF THE PREFERRED EMBODIMENTS

Several embodiments of the present invention will now be described in detail with reference to the accompanying drawings. In the following description, a detailed description of known functions and configurations incorporated herein has been omitted for conciseness.

The present invention provides an apparatus and method for controlling a rate of a reverse traffic channel by adjusting transition-to-high-rate probability and transition-to-low-rate probability in a mobile communication system supporting a packet data service.

According to an embodiment of the present invention, a mobile terminal receives a plurality of selectable transition probability sets from a base station or via other paths, and stores the received transition probability sets. There are four possible embodiments for selecting a transition probability set to be used by the mobile terminal among the plurality of transition probability sets. In addition, the four embodiments can be divided according to whether the transition probability set is selected by a base station or a mobile terminal.

For example, in first and second embodiments of the present invention, a mobile terminal selects one of the transition probability sets.

In the first embodiment of the present invention, a mobile terminal estimates a channel condition of a reverse link based on a signal-to-noise ratio (SNR) measured from a forward pilot channel, selects a different transition probability set according to the estimation result, and then controls a reverse rate using the selected transition probability set.

In the second embodiment of the present invention, a mobile terminal estimates a channel condition of a reverse link depending on throughput of a forward data channel, and uses a different transition probability set according to the estimation result. Here, the mobile terminal has a plurality of transition probability sets stored therein, and controls a reverse rate using a transition probability set designated according to throughput of a forward data channel.

For example, in third and fourth embodiments of the present invention, a base station selects one of the transition probability sets, and sends the selected probability set to a mobile terminal.

In the third embodiment, a base station designates one of a plurality of transition probability sets according to the number of mobile terminals and a load of a reverse link, and sends the designated transition probability set to a mobile terminal, and the mobile terminal then controls a reverse rate using the designated transition probability set.

In the fourth embodiment of the present invention, a base station uses an offset for one transition probability set according to the number of mobile terminals and a load of a reverse link. A mobile terminal receives a transition probability set from the base station, and if the base station designates an appropriate transition probability set according to the number of mobile terminals and a load of a reverse link, then the mobile terminal corrects transition probabilities in the transition probability set according to the offset, and uses the corrected transition probabilities in controlling a reverse rate.

A detailed description will now be made of the first to fourth embodiments of the present invention.

Embodiment 1

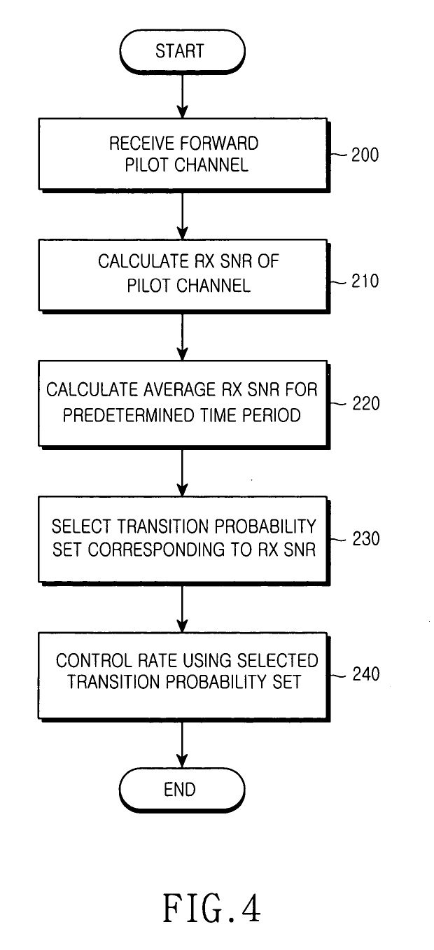

FIG. 4 is a flowchart illustrating an operation of controlling a reverse rate using a reception signal-to-noise ratio (SNR) of a forward pilot channel in a mobile terminal according to a first embodiment of the present invention. This operation is performed by one or more base stations and a mobile terminal in packet data service, and the mobile terminal has a plurality of transition probability sets each comprising transition-to-high-rate probabilities and transition-to-low-rate probabilities. The “transition-to-high-rate probability” refers to transition probability to a high rate among a plurality of predetermined transition probabilities, while the “transition-to-low-rate probability” refers to transition probability to a low rate.

Referring to FIG. 4, a mobile terminal receives a signal on a forward pilot channel in step 200, and calculates a signal-to-noise ratio of the received forward pilot channel signal in step 210. The signal-to-noise ratio is calculated including noises and interference of a forward link altogether. If an average signal-to-noise ratio is determined in step 220 by low-pass-filtering the calculated signal-to-noise ratio for a predetermined time, then the mobile terminal selects one transition probability set corresponding to the determined average signal-to-noise ratio among a plurality of transition probability sets previously stored therein in step 230. Thereafter, in step 240, the mobile terminal controls a reverse rate using the selected transition probability set.

This embodiment estimates a channel condition of a reverse link using a reception signal-to-noise ratio measured on a forward pilot channel, and controls a rate of a reverse link by selecting a transition probability set according to the estimation result. The reception signal-to-noise ratio measured on a forward pilot channel is used for estimating a channel condition of a reverse link. The mobile terminal utilizes a forward signal-to-noise ratio which is periodically reported by a forward link for adaptive modulation and coding scheme (AMCS) and scheduling.

A reception signal-to-noise ratio corresponds to Data Rate Control (DRC) defined in Evolution Data Only (1× EV-DO) or Channel Quality Indicator (CQI) defined in 1× EV-DV and High Speed Downlink Packet Access (HSDPA). Here, since DRC and CQI both are used for reporting a condition of a forward pilot channel, i.e., reception signal-to-noise ratio, to a base station, an average can be calculated by determining a corresponding reception signal-to-noise ratio using transition probabilities.

A reception signal-to-noise ratio of a forward pilot channel is determined using channel loss and interference. Here, the channel loss is expressed as the product of a long-term loss and a short-term loss as defined in Equation (3) below.

Channel Loss=(Long-term Loss)−(Short-term Loss) (3)

The long-term loss, a loss caused by a propagation loss and shadowing, is generated based on a distance between a base station and a mobile terminal and a surrounding environment, and has the same value in both a forward link and a reverse link. The short-term loss is generated based on multipath fading and changed according to moving velocity and a frequency in use, so it has different values in a forward link and a reverse link that use different bands. Because of such a short-term loss, it is not possible to correctly estimate a channel loss of a reverse link from a channel loss of a forward link. However, if a channel loss of a forward link is averaged for a long time, a short-term loss is averaged, so a long-term loss can be estimated. The estimated value becomes approximate to a long-term loss of a reverse link.

Therefore, a mobile terminal estimates channel condition information of a reverse link by considering a long-term loss determined by averaging a signal-to-noise ratio measured on a forward pilot channel for a long time, and utilizes the estimated channel condition information in controlling a reverse rate. A time period required for determining an average of a reception signal-to-noise ratio is set as short as the short-term loss can be ignored, and it is experimentally determined according to system characteristic. For example, the time period can become about 10 times a coherence time used in determining a reception signal-to-noise ratio.

A long-term average signal-to-noise ratio SNRₖ for a k^{th} bases station among a plurality of base stations in communication with the mobile terminal is expressed as

$${SNR}_{k} = \frac{{α}_{k} {I}_{or}}{{N}_{O} + {𝒬}_{i} {α}_{i} {I}_{or}} = \frac{{α}_{k}}{\frac{{N}_{O}}{{I}_{or}} + {𝒬}_{i} {α}_{i}} \qquad ( 4 )$$

In Equation (4), αᵢ denotes a long-term loss (or gain) for an i^{th} base station, and Iₒᵣ denotes transmission power of the base station. Herein, it is assumed that all base stations in communication with the mobile terminal have the same transmission power. In addition, N_{O} denotes thermal noise of the k^{th} base station. If the thermal noise is ignored, a numerator of Equation (4) becomes a channel loss (or gain) for the k^{th} base station and a denominator of Equation (4) becomes the sum of channel losses (or gains) for other base stations.

As the numerator become larger, a channel loss for the k^{th} base station decreases, resulting in a decrease in transmission power needed when a mobile terminal uses a high reverse rate. As the denominator decreases, channel losses for other base stations become larger, causing a reduction in interference to the other base stations when the mobile terminal uses the same power. That is, if a high rate is assigned to a mobile terminal having a high-signal-to-noise ratio, it is possible to reduce interference to other base stations while saving power of the mobile terminal, for the same rate.

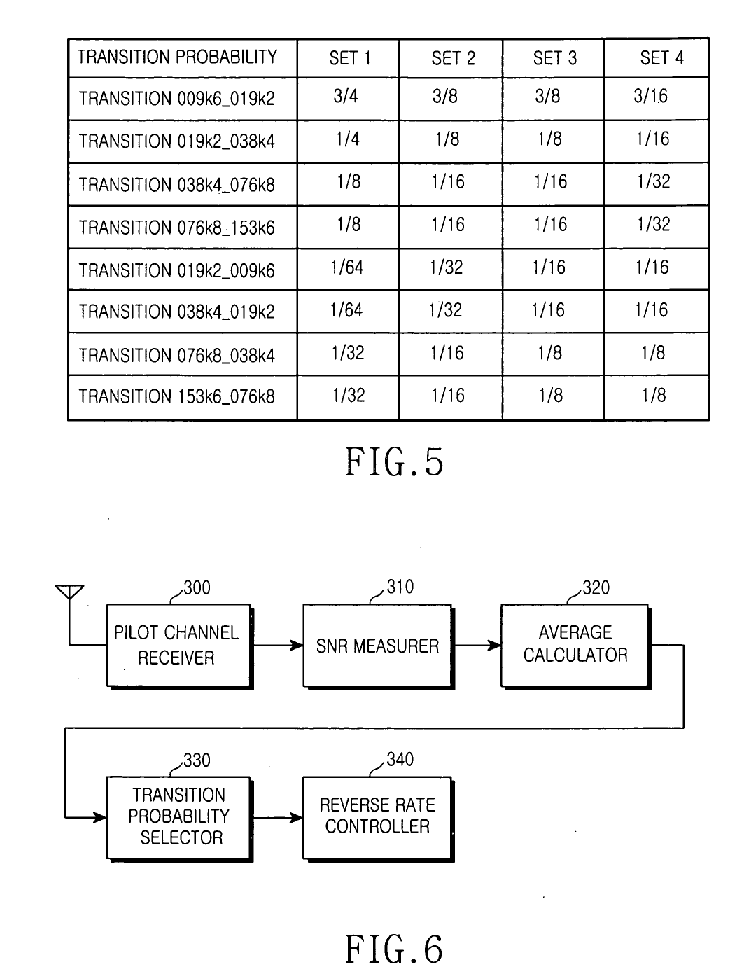

An example of a table of transition probability sets that a mobile terminal can select depending on the signal-to-noise ratio calculated in this manner is illustrated in FIG. 5. Referring to FIG. 5, for a reverse traffic channel, there are 5 possible rates of 9.6 Kbps, 19.2 Kbps, 38.4 Kbps, 76.8 Kbps, and 153.6 Kbps, and one of the 5 possible rates is selected according to Reverse Activity Bit (RAB), transition probability) and rate limit parameters received from a base station. For example, for Set 1, transition-to-high-rate probabilities are determined as Transition009k6_{—}019k2=3/4, Transition019k2_{—}038k4=1/4, Transition038k4_{—}076k8=1/8 and Transition076k8_{—}153k6=1/8, while transition-to-low-rate probabilities are determined as Transition019k2_{—}009k6=1/64, Transition038k4_{—}019k2=1/64, Transition076k8_{—}038k4=1/32 and Transition153k6_{—}076k8=1/32.

Table 2 below shows an example of a mapping relationship between signal-to-noise ratios and transition probability sets with reference to FIG. 5.

TABLE 2

| Forward SNR | | Transition Probability Set |
|---|---|---|
| −5 | dB or below | Set 4 |
| −5˜0 | dB | Set 3 |
| 0˜5 | dB | Set 2 |
| 5 | dB or above | Set 1 |

As a forward signal-to-noise ratio increases, a transition probability set in which transition-to-high-rate probability is high and transition-to-low-rate probability is low is assigned. As a result, a mobile terminal having a high forward signal-to-noise ratio uses a relatively high rate and a mobile terminal having a low forward signal-to-noise ratio uses a relatively low rate, thus contributing to a remarkable reduction in the sum of output powers of all the mobile terminals, a reduction in interference to other base stations, an increase in forward and reverse throughputs, and efficient utilization of a reverse critical limit.

When a transition probability set is selected, a mobile terminal analyzes a value of RAB included in each frame received from a base station. If a value of RAB is ‘0’, the mobile terminal selects transition-to-high-rate probability corresponding to a current rate from the selected transition probability set, and if a random number generated with uniform distribution between 0 and 1 is smaller than the transition-to-high-rate probability, the mobile terminal transitions to a next high rate. In contrast, if a value of RAB is ‘1’, the mobile terminal selects transition-to-low-rate probability corresponding to the current rate from the selected transition probability set, and if a random number generated with uniform distribution between 0 and 1 is smaller than the transition-to-low-rate probability, the mobile terminal transitions to a next low rate.

Thereafter, the mobile terminal determines a reverse rate according to the new rate, a predetermined rate limit, possible transmission power, and an amount of transmission packet data, and transmits reverse data at the determined reverse rate.

FIG. 6 is a block diagram illustrating a mobile terminal apparatus for controlling a reverse rate using a reception signal-to-noise ratio of a forward pilot channel according to the first embodiment of the present invention. Referring to FIG. 6, a pilot channel receiver 300 receives a signal on a pilot channel for a forward link and demodulates the received pilot channel signal, and a signal-to-noise ratio measurer 310 calculates a signal-to-noise ratio for the demodulated pilot channel signal. An average calculator 320 determines a long-term average for the calculated signal-to-noise ratio. A transition probability set selector 330 selects a transition probability set corresponding to the average signal-to-noise ratio calculated by the average calculator 320 from a plurality of previously stored transition probability sets, and a reverse rate controller 340 determines a rate of a reverse data channel using the selected transition probability set.

Embodiment 2

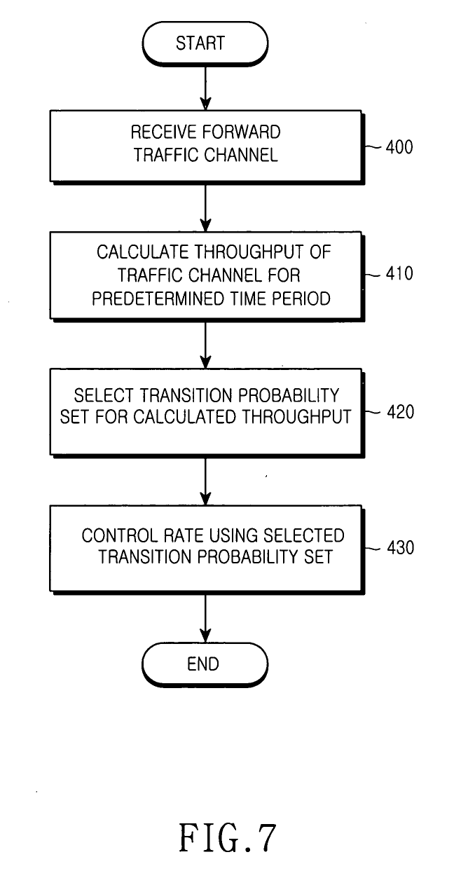

FIG. 7 is a flowchart illustrating an operation of controlling a reverse rate using throughput of a forward data channel in a mobile terminal according to a second embodiment of the present invention. This operation is performed by one or more base stations and a mobile terminal in packet data service, and the mobile terminal has a plurality of transition probability sets each comprising transition-to-high-rate probabilities and transition-to-low-rate probabilities. The “transition-to-high-rate probability” refers to transition probability to a high rate among a plurality of predetermined transition probabilities, while the “transition-to-low-rate probability” refers to transition probability to a low rate.

Referring to FIG. 7, a mobile terminal receives a signal on a forward data channel for a predetermined time period in step 400, and calculates throughput of the received forward data channel signal in step 410. In step 420, the mobile terminal selects one transition probability set corresponding to the calculated throughput among a plurality of transition probability sets previously stored therein. Thereafter, in step 430, the mobile terminal controls a reverse rate using the selected transition probability set.

This embodiment utilizes throughput of a forward data channel for each mobile terminal in order to estimate a channel condition of a reverse link. Forward data throughput of each mobile terminal is changed according to a scheduling method of a forward link, and is determined according to the number of mobile terminals in a cell and a channel condition of a forward link for a corresponding mobile terminal.

In determining a reverse rate, if the number of mobile terminals in a cell is small, a reverse rate per mobile terminal can be increased, whereas if the number of mobile terminals is large, a reverse rate per mobile terminal must be decreased. By allowing a mobile terminal having a high average reception signal-to-noise ratio to use a relatively high rate and allowing a mobile terminal having a low average reception low-signal-to-noise ratio to use a relatively low rate, it is possible to reduce the output power of a mobile terminal and reduce interference to other base stations, for the same rate. Throughput of a forward link for each mobile terminal is generally related to the number of mobile terminals and an average reception signal-to-noise ratio of a forward link for a corresponding mobile terminal. As the number of mobile terminals in a cell decreases, the throughput increases, and as the average reception signal-to-noise ratio of a forward link for a corresponding mobile terminal increases, the throughput increases. Therefore, taking this into consideration, it is possible to utilize forward throughput as an index for determining a reverse rate. That is, by assigning a high rate for high forward throughput of a corresponding mobile terminal and a low rate for low forward throughput, it is possible to reduce the power of the mobile terminal and reduce interference to other base stations for the same rate, thus contributing to efficient transmission.

Table 3 below shows an example of a mapping relationship between forward link throughputs and transition probability sets. Herein, the transition probability sets illustrated in FIG. 5 are considered.

TABLE 3

| Forward Throughput | | Transition Probability Set |
|---|---|---|
| 30 | Kbps or below | Set 4 |
| 30˜100 | Kbps | Set 3 |
| 100˜300 | Kbps | Set 2 |
| 300 | Kbps or above | Set 1 |

Here, the forward throughput is determined by dividing an amount of reception data of each mobile terminal by time.

As illustrated in Table 3, as forward throughput increases, a transition probability set in which transition-to-high-rate probability is high and transition-to-low-rate probability is low is selected. As a result, a mobile terminal having high forward throughput uses a relatively high rate and a mobile terminal having a low forward throughput uses a relatively low rate.

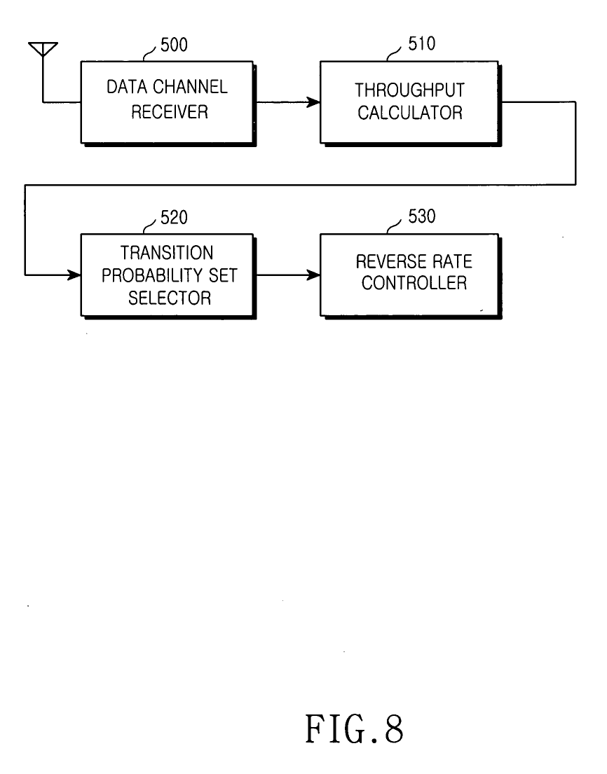

FIG. 8 is a block diagram illustrating a mobile terminal apparatus for controlling a reverse rate using throughput of a forward data channel according to the second embodiment of the present invention. Referring to FIG. 8, a data channel receiver 500 receives a data channel signal of a forward link for a predetermined time period and demodulates the received data channel signal, and a throughput calculator 510 calculates throughput for the demodulated data channel signal for the predetermined time period. A transition probability set selector 520 selects a transition probability set corresponding to the calculated throughput from a plurality of previously stored transition probability sets, and a reverse rate controller 530 determines a rate of a reverse data channel using the selected transition probability set.

Embodiment 3

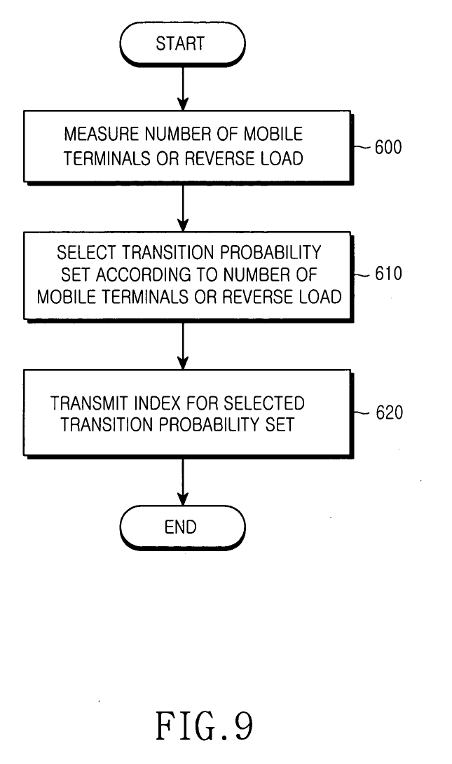

FIG. 9 is a flowchart illustrating an operation of controlling a reverse rate in a base station using a plurality of transition probability sets according to a third embodiment of the present invention. This operation is performed by one or more mobile terminals in a cell and a base station in packet data service, and the base station previously has an index for a transition probability set capable of achieving maximum throughput while maintaining a reverse load below a threshold for the number of mobile terminals or each of reverse loads by simulation or calculation. The transition probability set consists of transition-to-high-rate probabilities and transition-to-low-rate probabilities. The “transition-to-high-rate probability” refers to transition probability to a high rate among a plurality of predetermined transition probabilities, while the “transition-to-low-rate probability” refers to transition probability to a low rate.

Referring to FIG. 9, a base station continuously measures in step 600 the number of mobile terminals currently receiving a packet data service in its cell or a load of a reverse link, and selects in step 610 an index for a transition probability set corresponding to the measured number of mobile terminals or the measured load of a reverse link. Thereafter, in step 620, the base station transmits the selected index for a transition probability set to mobile terminals in its cell over a common control channel or a dedicated control channel.

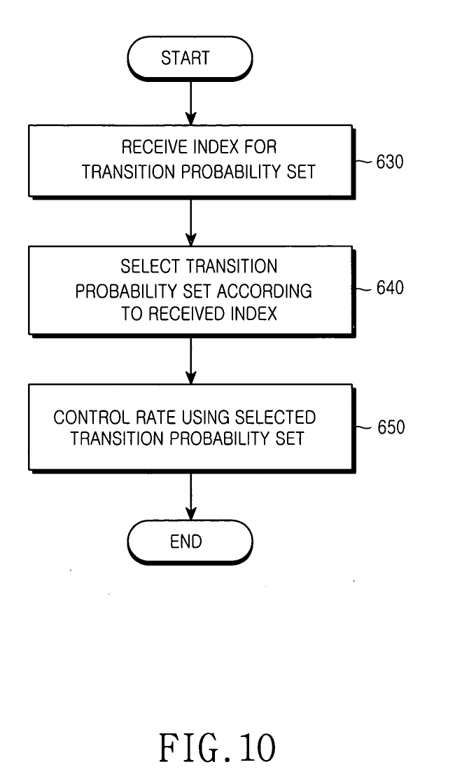

FIG. 10 is a flowchart illustrating an operation of controlling a reverse rate in a mobile terminal. This operation corresponds to the operation of FIG. 9. Here, the mobile terminal has a plurality of transition probability sets each comprising transition-to-high-rate probabilities and transition-to-low-rate probabilities. The transition probability sets are previously designated by a mobile communication standard or received from a base station during call setup.

Referring to FIG. 10, a mobile terminal receives in step 630 an index for a transition probability set from a base station, and selects in step 640 a corresponding transition probability set among a plurality of previously stored transition probability sets using the index. Thereafter, in step 650, the mobile terminal controls a reverse rate using the selected transition probability set.

The procedures illustrated FIGS. 9 and 10 are periodically repeated while the base station and the mobile terminal are performing a packet data service.

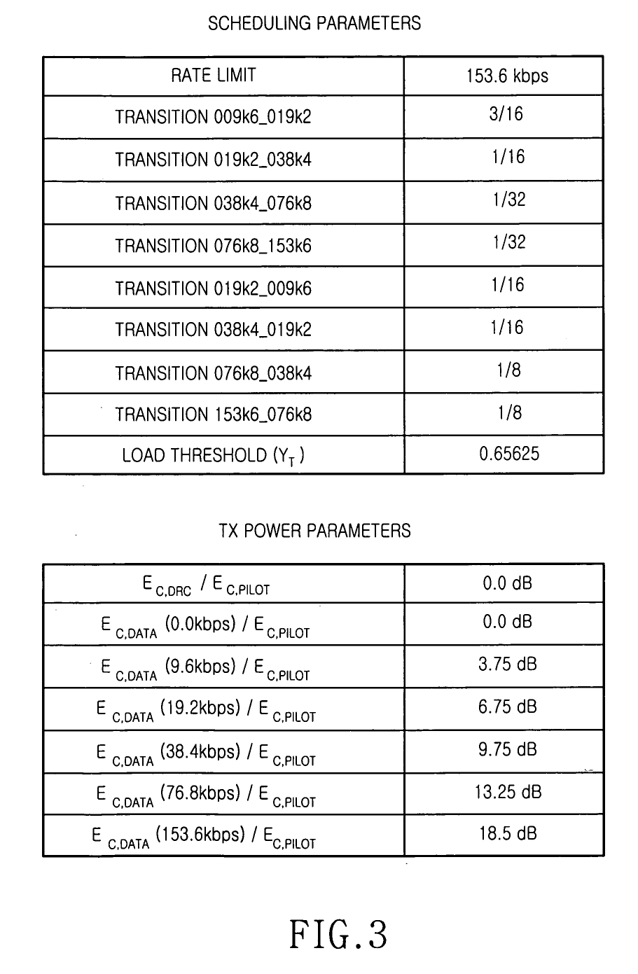

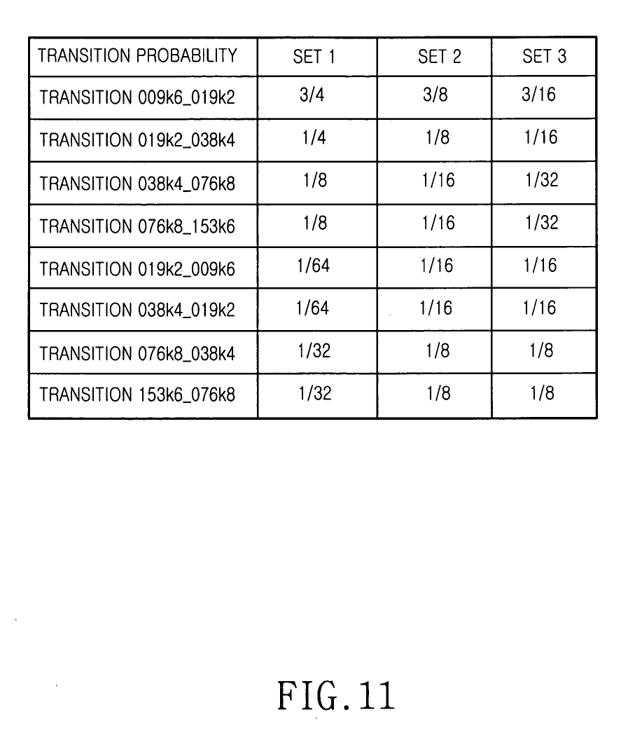

Table 4 below shows reverse throughput simulation results according to the third embodiment of the present invention. Herein, the throughput calculation formula of Equation (1) was used, and the values shown in FIG. 3 were used as scheduling parameters, i.e., such parameters as rate limit, transition probability and transmission power including E_{C,DRC}/E_{C,PILOT} and E_{C,DATA}(Rₖ)/E_{C,PILOT}. In addition, it is assumed that the mobile terminal previously stored 3 transition probability sets shown in FIG. 11.

TABLE 4

| | | | | Increment of |
|---|---|---|---|---|
| Number of | Selected | Throughput | Reverse | Throughput over Prior |
| Terminals | Set | (Kbps) | Load | Art |
| 4 | Set 1 | 305.39 | 0.62 | 23.13% |
| 8 | Set 2 | 280.22 | 0.62 | 4.67% |
| 12 | Set 3 | 250.06 | 0.63 | 0.0% |
| 16 | Set 3 | 217.82 | 0.68 | 0.0% |

Comparing Table 4 with Table 2, when the number of mobile terminals is small, i.e., when a reverse load has a margin, considerable throughput improvement is achieved. In this manner, the first embodiment makes the best use of a high rate available when the number of mobile terminals is small, thereby achieving higher throughput as compared with when the number of mobile terminals is large. Here, the reverse load is maintained at the same level as that given when the number of mobile terminals is large, and approximates 0.65625 which is used as a threshold in FIG. 3. In this manner, the third embodiment can achieve throughput that could not be achieved because of the limitation on conservative transition provability when the number of mobile terminals is small, and uses up to a load limit that can be used in a reverse link, thereby contributing to an increase in efficiency of throughput.

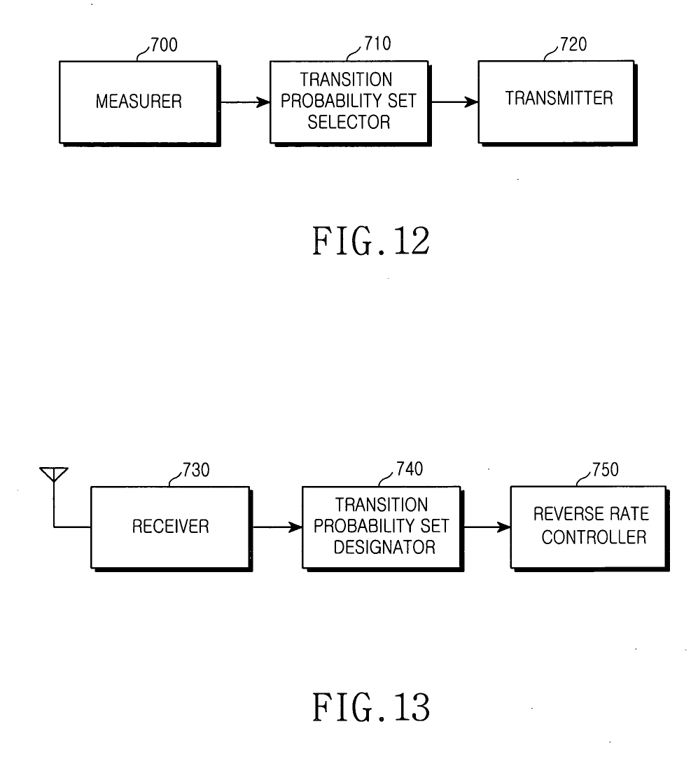

FIGS. 12 and 13 are block diagrams illustrating a base station apparatus and a mobile terminal apparatus for controlling a reverse rate using a plurality of transition probability sets according to the third embodiment of the present invention, respectively.

Referring to FIG. 12, a measurer 700 continuously measures the number of mobile terminals in a packet data service by a base station or a reverse load, and a transition probability set selector 710 selects an index for the most appropriate transition probability set according to the measured number of mobile terminals or the measured reverse load. A transmitter 720 transmits the selected index to mobile terminals in a cell by transmitting it on a message or a signal having a predetermined format.

Referring to FIG. 13, a receiver 730 receives an index for a transition probability set from a base station, and a transition probability set designator 740 designates a transition probability set to be used in controlling a reverse rate, according to the received index. A reverse rate controller 750 then determines a rate of a reverse data channel using transition probabilities in the designated transition probability set.

Embodiment 4

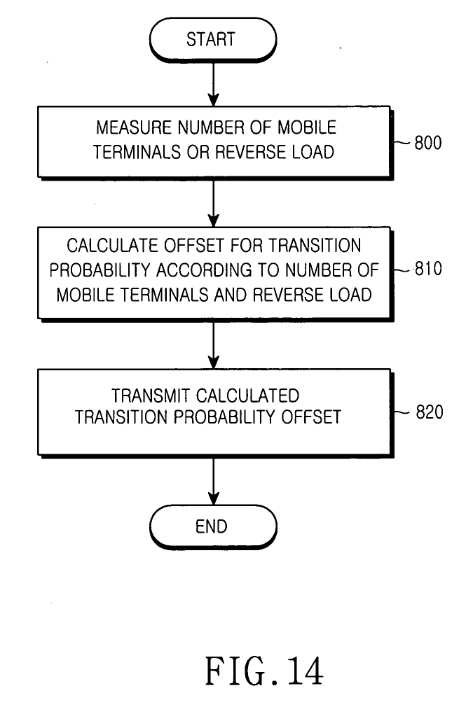

FIG. 14 is a flowchart illustrating an operation of controlling a reverse rate in a base station using a reference transition probability set and a transition probability offset according to a fourth embodiment of the present invention. This operation is performed by one or more mobile terminals in a cell and a base station in packet data service, and the base station previously has an offset for transition probability sets capable of achieving maximum throughput while maintaining a reverse load below a threshold for the number of mobile terminals or each of reverse loads by simulation or calculation. The offset is provided to separately or simultaneously control transition-to-high-rate probabilities and transition-to-low-rate probabilities with respect to a reference transition probability set the mobile terminal previously has.

Referring to FIG. 14, a base station measures in step 800 the number of mobile terminals currently receiving a packet data service in its cell or a load of a reverse link, and selects in step 810 a transition probability offset corresponding to the measured number of mobile terminals or the measured load of a reverse link. Thereafter, in step 820, the base station transmits the selected transition probability offset to mobile terminals in its cell over a common control channel or a dedicated control channel.

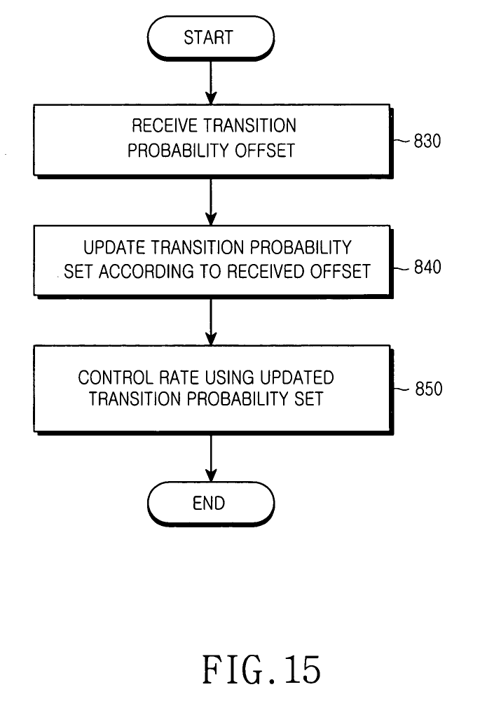

FIG. 15 is a flowchart illustrating an operation of controlling a reverse rate in a mobile terminal. This operation corresponds to the operation of FIG. 14. Here, the mobile terminal has one reference transition probability set comprising transition-to-high-rate probabilities and transition-to-low-rate probabilities. The reference transition probability set is previously designated by a mobile communication standard or received from a base station during call setup.

Referring to FIG. 15, a mobile terminal receives in step 830 a transition probability offset from a base station, and updates in step 840 transition probabilities in its reference transition probability set using the transition probability offset. Thereafter, in step 850, the mobile terminal controls a reverse rate using the updated transition probability.

The procedures illustrated FIGS. 14 and 15 are periodically repeated while the base station and the mobile terminal are performing a packet data service.

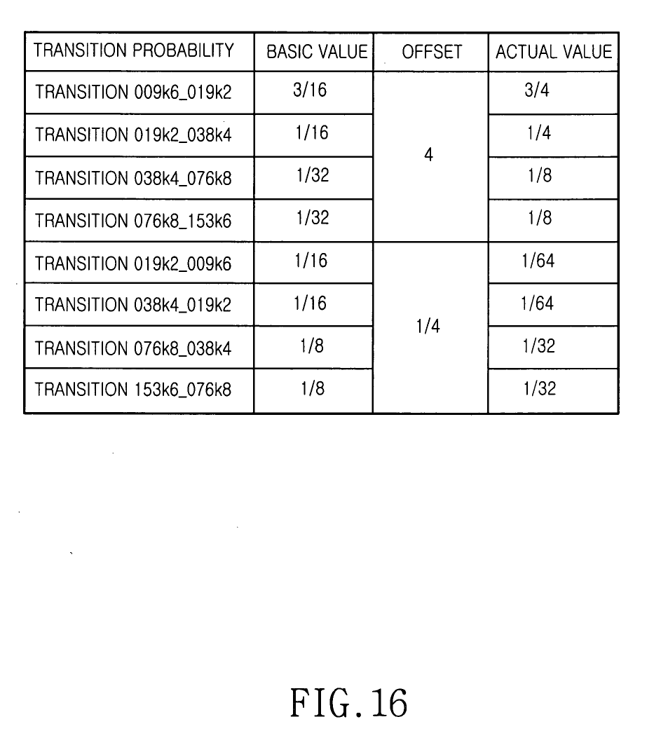

An example of a table of reference transition probability sets and transition probability offsets used in the fourth embodiment is illustrated in FIG. 16. In FIG. 16, an offset for transition-to-high-rate probabilities is 4, while an offset for transition-to-low-rate probabilities is 1/4. Shown in the last column of FIG. 16 are transition probabilities updated by the offset values. As illustrated, when transition-to-high-rate probabilities 3/16, 1/16, 1/32, and 1/32 are updated by an offset 4, they become 3/4, 1/4, 1/8, and 1/8, and when transition-to-low-rate probabilities 1/16, 1/16, 1/8, and 1/8 are updated by an offset 1/4, they become 1/64, 1/64, 1/32, and 1/32.

Table 5 below shows another example of offsets that can be selected by a base station according to the number of mobile terminals.

TABLE 5

| Number of | Offset for Transition-to-High- | Offset for Transition-to-Low- |
|---|---|---|
| Terminals | Rate Probability | Rate Probability |
| 4 | 4 | ¼ |
| 8 | 2 | 1 |
| 12 | 1 | 1 |
| 16 | 1 | 1 |

Assigning offsets according to the number of mobile terminals as shown in Table 5 is equivalent to using a different transition probability set according to the number of mobile terminals.

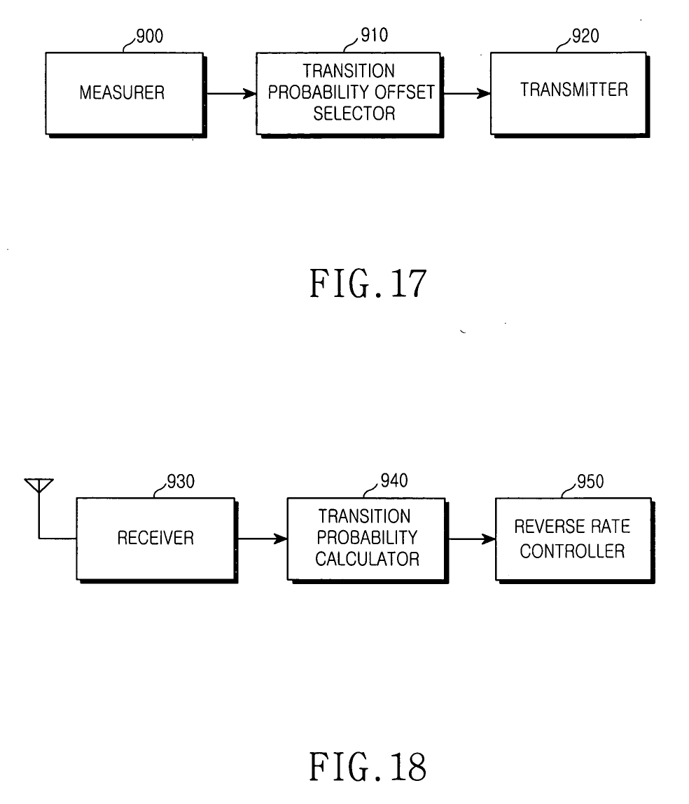

FIGS. 17 and 18 illustrate a base station apparatus and a mobile terminal apparatus for controlling a reverse rate using one reference transition probability set and transition probability offsets according to the fourth embodiment of the present invention, respectively.

Referring to FIG. 17, a measurer 900 continuously measures the number of mobile terminals in packet data service by a base station or a reverse load, and a transition probability offset selector 910 selects the most appropriate transition probability offset corresponding to the measured number of mobile terminals or the measured reverse load. A transmitter 920 transmits the selected transition probability offset to mobile terminals in a cell by transmitting it on a message or a signal having a predetermined format.

Referring to FIG. 18, a receiver 930 receives a transition probability offset from a base station, and a transition probability calculator 940 calculates transition probabilities to be actually used, by updating transition probabilities in a reference transition probability set previously stored therein by the received transition probability offset. A reverse rate controller 950 determines a rate of a reverse data channel using the calculated transition probabilities.

In sum, the present invention estimates a reverse channel condition based on a forward reception signal-to-noise ratio or forward throughput of each mobile terminal with respect to transition probabilities used in determining a rate of a reverse data channel of a mobile communication system for packet data, and applies a different transition probability according to the estimation result. By allowing a mobile terminal having a good channel condition to be assigned a high rate and a mobile terminal having a poor channel condition to be assigned a low rate, the present invention reduces the sum of output powers of all mobile terminals for the same reverse load and reduces interference to other base stations, thereby contributing to an improvement of throughput of a verse link and efficient utilization of a reverse load.

In addition, by changing transition probabilities used in determining a rate of a reverse data channel of a mobile communication system for packet data according to the number of mobile terminals in a cell and a reverse load, the invention improves reverse throughput restricted when the number of mobile terminals is small or there is a margin in a load because of transition probability fixed to a conservative value and uses up to a limit reverse load that can be accepted in a reverse link, thereby contributing to efficient resource management.

While the invention has been shown and described with reference to certain embodiment thereof, it will be understood by those skilled in the art that various changes in form and details may be made therein without departing from the spirit and scope of the invention as defined by the appended claims.

What is claimed is:

1. A method for controlling a transmission rate of data in a reverse direction in a mobile communication system, the method comprising the steps of:
receiving a radio frequency (RF) encoder data transmitted from a transmitter of a base station;
converting the received high-rate RF encoder packet into a baseband signal;
determining a signal-to-noise ratio of the baseband signal, and selecting one transition probability set from predetermined transition probability sets according to the signal-to-noise ratio; and
selecting one transition probability from the selected transition probability set according to reverse rate control information received from the base station, and changing the transmission rate according to the selected transition probability.

2. The method of claim 1, wherein the signal-to-noise ratio determining step further comprises the step of determining an average of signal-to-noise ratios for a predetermined time period in order to estimate a long-term loss of a forward link.

3. The method of claim 2, wherein the average of signal-to-noise ratios is measured on a forward pilot channel received from the base station.

4. The method of claim 1, wherein the transition probability sets are broadcast to mobile terminals by the base station over a forward channel.

5. The method of claim 1, wherein the transition probability sets comprise transition-to-high-rate probabilities representing transition probabilities to a high rate and transition-to-low-rate probabilities representing transition probabilities to a low rate.

6. The method of claim 5, wherein the transition-to-high-rate probabilities have higher values as the determined signal-to-noise ratio increases, and the transition-to-low-rate probabilities have lower values as the determined signal-to-noise ratio decreases.

7. A mobile terminal apparatus for controlling a transmission rate of data in a reverse direction in a mobile communication system, the apparatus comprising:
an antenna for receiving a radio frequency (RF) encoder transmitted from a transmitter of a base station;
an RF section for converting the high-rate RF encoder packet received from the antenna into a baseband signal;
a measurer for measuring a signal-to-noise ratio of the baseband signal;
a selector for selecting one transition probability set from predetermined transition probability sets according to the signal-to-noise ratio; and
a reverse rate controller for selecting one transition probability from the selected transition probability set according to reverse rate control information from the base station, and changing the transmission rate according to the selected transition probability.

8. The mobile terminal apparatus of claim 7, further comprising an average calculator for determining an average of signal-to-noise ratios by the measurer for a predetermined time period, in order to estimate a long-term loss of a forward link.

9. The mobile terminal apparatus of claim 8, wherein the average of signal-to-noise ratios is measured on a forward pilot channel received from the base station.

10. The mobile terminal apparatus of claim 9, wherein the transition probability sets are broadcast to mobile terminals by the base station over a forward channel.

11. The mobile terminal apparatus of claim 7, wherein the transition probability sets comprise transition-to-high-rate probabilities representing transition probabilities to a high rate and transition-to-low-rate probabilities representing transition probabilities to a low rate.

12. The mobile terminal apparatus of claim 6, wherein the transition-to-high-rate probabilities have higher values as the determined signal-to-noise ratio increases, and the transition-to-low-rate probabilities have lower values as the determined signal-to-noise ratio decreases.

13. A method for controlling a transmission rate of data in a reverse direction in a mobile communication system, the method comprising the steps of:
receiving a radio frequency (RF) encoder data transmitted from a transmitter of a base station;
converting the received high-rate RF encoder packet into a baseband signal;
determining a throughput for forward data, and selecting one from predetermined transition probability sets according to the forward data throughput; and
selecting one transition probability from the selected transition probability set according to reverse rate control information, and changing the transmission rate according to the selected transition probability.

14. The method of claim 13, wherein the forward data throughput determining step comprises the step of determining the throughput of forward data for a predetermined time period by the time period.

15. The method of claim 14, wherein the throughput of forward data is measured by dividing an amount of data received from the base station over a forward data channel.

16. The method of claim 13, wherein the transition probability sets are broadcast to mobile terminals by the base station over a forward channel.

17. The method of claim 13, wherein the transition probability sets comprise transition-to-high-rate probabilities representing transition probabilities to a high rate and transition-to-low-rate probabilities representing transition probabilities to a low rate.

18. The method of claim 17, wherein the transition-to-high-rate probabilities have higher values as the determined forward data throughput increase, and the transition-to-low-rate probabilities have lower values as forward data throughput decrease.

19. A mobile terminal apparatus for controlling a transmission rate of data in a reverse direction in a mobile communication system, the apparatus comprising:
an antenna for receiving a radio frequency (RF) encoder transmitted from a transmitter of a base station;
an RF section for converting the high-rate RF encoder packet received from the antenna into a baseband signal;
a measurer for measuring throughput of a forward channel;
a selector for selecting one from predetermined transition probability sets according to the throughput of a forward channel; and
a reverse rate controller for selecting one transition probability from the selected transition probability set according to reverse rate control information, and changing the transmission rate according to the selected transition probability.

20. The mobile terminal apparatus of claim 19, wherein transition probability sets are broadcast to mobile terminals by the base station over a forward channel.

21. The method of claim 19, wherein the transition probability sets comprise transition-to-high-rate probabilities representing transition probabilities to a high rate and transition-to-low-rate probabilities representing transition probabilities to a low rate.

22. The method of claim 21, wherein the transition-to-high-rate probabilities have higher values as forward data throughput increases, and the transition-to-low-rate probabilities have lower values as forward data throughput decrease.

23. A method for controlling by a base station a transmission rate of data in a reverse direction in a mobile communication terminal, the method comprising the steps of:
receiving a radio frequency (RF) encoder data transmitted from a transmitter of a base station;
converting the received high-rate RF encoder packet into a baseband signal;
determining a reverse load in a base station area, and selecting one from predetermined transition probability sets according to the reverse load; and
transmitting indication information for the selected transition probability set to mobile terminals in the base station area, generating reverse rate control information for controlling a reverse rate based on the transition probability set information, and transmitting the generated reverse rate control information.

24. The method of claim 23, wherein the reverse load determining step comprises the step of measuring the number of mobile terminals in packet data service.

25. The method of claim 23, wherein the step of selecting one of transition probability sets further comprises the step of selecting a transition probability set capable of achieving maximum reverse throughput while maintaining a reverse load below a threshold.

26. The method of claim 23, wherein the transition probability sets are broadcast to mobile terminals by the base station via a forward channel.

27. The method of claim 23, wherein the transition probability sets comprise transition-to-high-rate probabilities representing transition probabilities to a high rate and transition-to-low-rate probabilities representing transition probabilities to a low rate.

28. The method of claim 27, wherein the transition-to-high-rate probabilities have lower values as the determined a reverse load increase, and the transition-to-low-rate probabilities have higher values as the determined signal-to-noise ration decrease.

29. The method of claim 23, wherein the indication information is transmitted over a common control channel or a dedicated control channel.

30. A method for controlling by a mobile terminal a transmission rate of data in a reverse direction in a mobile communication system, the method comprising the steps of:
receiving a radio frequency (RF) encoder data transmitted from a transmitter of a base station;
converting the received high-rate RF encoder packet into a baseband signal;
receiving indication information for a transition probability set from a base station;
selecting one transition probability set corresponding to the received indication information; and
selecting one transition probability from the selected transition probability sets according to reverse rate control information.

31. The method of claim 30, wherein the transition probability sets comprise transition-to-high-rate probabilities representing transition probabilities to a high rate and transition-to-low-rate probabilities representing transition probabilities to a low rate.

32. The method of claim 30, wherein the transition probability sets are broadcast to mobile terminals by the base station over a forward channel.

33. The method of claim 30, wherein the transition probability set received from the base station is capable of achieving maximum reverse throughput while maintaining a reverse load below a threshold.

34. The method of claim 30, wherein the indication information is transmitted over a common control channel or a dedicated control channel.

35. A base station apparatus for controlling a transmission rate of data in a reverse direction in a mobile communication system, the apparatus comprising:
an antenna for receiving a radio frequency (RF) encoder transmitted from a transmitter of a base station;
an RF section for converting the high-rate RF encoder packet received from the antenna into a baseband signal;
a measurer for measuring a reverse load in a base station area;
a selector for selecting one from predetermined transition probability sets according to a value of the reverse load; and
a transmitter for transmitting indication information for the selected transition probability set to a mobile terminal in the base station area.

36. The base station apparatus of claim 35, wherein the measurer measures the number of mobile terminals in packet data service.

37. The base station apparatus of claim 35, wherein the selector selects a transition probability set capable of achieving maximum throughput while maintaining a reverse load below a threshold.

38. The base station apparatus of claim 35, wherein the transition probability sets are broadcast to mobile terminals by the base station over a forward channel.

39. The base station apparatus of claim 35, wherein the transition probability sets comprise transition-to-high-rate probabilities representing transition probabilities to a high rate and transition-to-low-rate probabilities representing transition probabilities to a low rate.

40. The base station apparatus of claim 39, wherein the transition-to-high-rate probabilities have lower values as the determined reverse load set increase, and the transition-to-low-rate probabilities have higher values as the determined signal-to-noise ratio decrease.

41. The base station apparatus of claim 35, wherein the indication information is transmitted over a common control channel or a dedicated control channel.

42. A mobile terminal apparatus for controlling a transmission rate of data in a reverse direction in a mobile communication system, the apparatus comprising:
an antenna for receiving a radio frequency (RF) encoder transmitted from a transmitter of a base station;
an RF section for converting the high-rate RF encoder packet received from the antenna into a baseband signal;
a receiver for receiving indication information for a transition probability set from a base station;
a selector for selecting one transition probability set corresponding to the received indication information among transition probability sets; and
a reverse rate controller for selecting one transition probability from the selected transition probability set according to reverse rate control information, and changing the transmission rate according to the selected transition probability.

43. The mobile terminal apparatus of claim 42, wherein the transition probability set received from the base station is capable of achieving maximum reverse throughput while maintaining a reverse load below a threshold.

44. The mobile terminal apparatus of claim 42, wherein the transition probability sets are broadcast to mobile terminals by the base station over a forward channel.

45. The mobile terminal apparatus of claim 43, wherein the transition probability sets comprise transition-to-high-rate probabilities representing transition probabilities to a high rate and transition-to-low-rate probabilities representing transition probabilities to a low rate.

46. The mobile terminal apparatus of claim 43, wherein the indication information is transmitted over a common control channel or a dedicated control channel.

47. A method for controlling via a base station a rate of data in a reverse direction in a mobile communication system providing a packet data service, the method comprising the steps of:
receiving a radio frequency (RF) encoder data transmitted from a transmitter of a base station;
converting the received high-rate RF encoder packet into a baseband signal;
determining a reverse load in a base station area, and selecting one of transition probability offsets for a reference transition probability set previously determined according to the reverse load; and
transmitting the selected offset to mobile terminals in the base station area, generating reverse rate control information for controlling a reverse rate based on the offset, and transmitting the generated revere rate control information.

48. The method of claim 47, wherein the reverse load determining step comprises the step of measuring the number of mobile terminals in packet data service.

49. The method of claim 47, wherein the transition probability set comprise transition-to-high-rate probabilities representing transition probabilities to a high rate and transition-to-low-rate probabilities representing transition probabilities to a low rate.

50. The method of claim 47, wherein the transition probability sets are broadcast to mobile terminals by the base station over a forward channel.

51. The method of claim 47, wherein the step of selecting an offset for a transition probability set comprises the step of selecting a transition probability offset for a transition probability set capable of achieving maximum reverse throughput while maintaining a reverse load below a threshold.

52. The method of claim 49, wherein the offset for a transition probability set comprises an offset for the transition-to-high-rate probabilities and an offset for the transition-to-low-rate probabilities.

53. The method of claim 52, wherein the offset for the transition-to-high-rate probabilities has a value for further decreasing the transition-to-high-rate probabilities as a corresponding reverse load becomes larger, and the offset for the transition-to-low-rate probabilities has a value for further increasing the transition-to-low-rate probabilities as a corresponding reverse load increases.

54. The method of claim 47, wherein the offset is transmitted over a common control channel or a dedicated control channel.

55. A method for controlling via a mobile terminal a transmission rate of data transmitted in a reverse direction from the mobile terminal in a mobile communication system, the method comprising the steps of:
receiving a radio frequency (RF) encoder data transmitted from a transmitter of a base station;
converting the received high-rate RF encoder packet into a baseband signal;
receiving a transition probability offset for a reference transition probability set previously determined according to a reverse load;
updating the reference transition probability set based on the received transition probability offset; and
selecting one transition probability from the updated transition probability set according to reverse rate control information received from the base station, and changing the transmission rate according to the selected transition probability.

56. The method of claim 55, wherein the offset is received over a common control channel or a dedicated control channel.

57. The method of claim 55, wherein the transition probability set comprises transition-to-high-rate probabilities representing transition probabilities to a high rate and transition-to-low-rate probabilities representing transition probabilities to a low rate.

58. A base station apparatus for controlling a transmission rate of data in a reverse direction in a mobile communication system, the apparatus comprising:
a measurer for measuring a reverse load in a base station area;
an antenna for receiving a radio frequency (RF) encoder transmitted from a transmitter of a base station;
an RF section for converting the high-rate RF encoder packet received from the antenna into a baseband signal;
a selector for selecting one of transition probability offsets for a reference transition probability set previously determined according to the reverse load; and
a transmitter for transmitting the selected transition probability offset to mobile terminals in the base station area.

59. The base station apparatus of claim 58, wherein the selector selects a transition probability offset for a transition probability set capable of achieving maximum throughput while maintaining a reverse load below a threshold.

60. The base station apparatus of claim 58, wherein the transition probability offset comprises an offset for transition-to-high-rate probabilities and an offset for transition-to-low-rate probabilities.

61. The base station apparatus of claim 60, wherein the offset for the transition-to-high-rate probabilities has a value for further decreasing the transition-to-high-rate probabilities as a corresponding reverse load becomes larger, and the offset for the transition-to-low-rate probabilities has a value for further increasing the transition-to-low-rate probabilities as a corresponding reverse load becomes larger.

62. The base station apparatus of claim 60, wherein the offset is transmitted over a common control channel or a dedicated control channel.

63. A mobile terminal apparatus for controlling a transmission rate of data in a reverse direction in a mobile communication system, the apparatus comprising:
an antenna for receiving a radio frequency (RF) encoder transmitted from a transmitter of a base station;
an RF section for converting the high-rate RF encoder packet received from the antenna into a baseband signal;
a receiver for receiving from a base station a transition probability offset for a transition probability set capable of achieving maximum throughput while maintaining a reverse load below a threshold;
a calculator for updating a reference transition probability set previously determined using the received transition probability offset; and
a reverse rate controller for selecting one transition probability from the updated transition probability set according to reverse rate control information received from the base station, and changing the transmission rate according to the selected transition probability.

64. The mobile terminal apparatus of claim 63, wherein the offset is received over a common control channel or a dedicated control channel.
